(19) United States
(12) Patent Application Publication
(10) Pub. No.: US 2019/0082465 A1
(43) Pub. Date: Mar. 14, 2019

(54) CONTROL APPARATUS, COMMUNICATION SYSTEM, AND COMMUNICATION METHOD

(71) Applicant: SHARP KABUSHIKI KAISHA, Sakai City, Osaka (JP)

(72) Inventors: TAKASHI YOSHIMOTO, Sakai City (JP); HIROMICHI TOMEBA, Sakai City (JP); YASUHIRO HAMAGUCHI, Sakai City (JP)

(21) Appl. No.: 16/084,282

(22) PCT Filed: Feb. 23, 2017
(86) PCT No.: PCT/JP2017/006874

§ 371 Date: Sep. 12, 2018

(30) Foreign Application Priority Data
Mar. 16, 2016 (JP) 2016-052037

(51) Int. Cl. H04W 74/08; H04W 74/06; H04W 16/14; H04W 88/10; H04W 88/12

(52) U.S. Cl. CPC H04W 74/0816; H04W 74/06; H04W 80/02; H04W 88/10; H04W 88/12; H04W 16/14

(57) ABSTRACT

An objective of the present invention is to provide, in a heterogeneous communication network constituted of multiple heterogeneous communication systems, a communication apparatus and a communication method for enabling optimization of radio resources, as a whole network. A control apparatus for communicating with a communication apparatus by using multiple communication methods includes a transmission and/or reception unit configured to transmit a medium reservation signal indicating that a radiowave is used in a prescribed frequency band by using a first communication method among the multiple communication methods, and subsequently transmit data by using at least one communication method among the multiple communication methods, and a radio resource manager configured to manage a radio resource in which data, is transmitted to the communication apparatus and configure a medium reservation duration indicating a duration in which the radiowave is used, the medium reservation signal includes a field for a medium reservation duration indicating a duration in which a radiowave is used, and the medium reservation duration is longer than a duration in which data is transmitted to the communication apparatus.

### TECHNICAL FIELD

The present invention relates to a control apparatus, a communication system, and a communication method.

### BACKGROUND ART

A heterogeneous communication network is built using heterogeneous radio communication systems (radio communication methods) such as a wireless LAN called. WiFi (trade name) including IEEE802.11b, g, n, or the like, and near field communication such as Bluetooth (trade name), and Bluetooth (trade name) Low Energy (BLE) (NPL 1, NPL 2, NPL 3). Many pieces of equipment such as information terminals including a smartphone and the like and sensors, are connected with the heterogeneous communication network. An optimum radio communication system is applied in the heterogeneous communication network, considering a transmission distance, power consumption, or the like, according to intended use.

An identical frequency band, in an unlicensed band or the like, is used for the above radio communication systems in some cases. For example, both the wireless LAN and Bluetooth (trade name) (including BLE) can use a 2.4 GHz industry Science Medical Band (ISM band). Accordingly, pieces of equipment equipped with the above-described radio communication systems interfere with each other. Bluetooth (trade name) and BLE use Adaptive Frequency Hopping (AFH) to reduce the interference (NPL 2). Equipment equipped with the wireless LAN uses Clear Channel Assessment for determining whether to transmit a frame after monitoring a usage condition of a radio channel, to avoid frame collision as possible.

### CITATION LIST

### Non Patent Literature

NPL 1: “3rd Generation Partnership Project Technical Specification Group Radio Access Network; Evolved Universal Terrestrial Radio Access (E-UTRA); Physical channels and modulation” 3GPP TS 36.211 v12.3.0, March 2014,

NPL 2: “IEEE Standard for Information technology—Local and metropolitan area networks—Specific requirements—Part 11:Wireless LAN Medium Access Control (MAC) and Physical Layer (PRY) Specifications: Further Higher Data Rate Extension in the 2.4 GHz Band” IEEE Std 802.11g-2003, June 2003

NPL 3: “Bluetooth SIG: Bluetooth specification version 4.2” February 2014 (https://www.bluetooth.orgija-jpispecificationladopted-specifications)

### SUMMARY OF INVENTION

### Technical Problem

In a heterogeneous communication network in which various radio communication systems using an identical frequency band coexist, congestion of channels for the respective radio communication systems occurs in terms of frequency and time. Under the above circumstance, each of the radio communication systems independently operates the AFH and the CCA in order to obtain a band to use. Accordingly, each of the radio communication systems scrambles for resources in terms of frequency and time. For example, in an area in which many pieces of communication equipment equipped with the wireless LAN exist, the wireless LAN frequently occupies frequency channels. Thus, communication equipment equipped with Bluetooth (trade name) (BT), in spite of requiring only a short time to communicate, cannot obtain a band to use. Additionally, transmit power for Bluetooth (trade name) is smaller than transmit power for the wireless LAN in general, and thus in a case that packets for Bluetooth and the wireless LAN collide, it is highly possible that packets for Bluetooth (trade name) or BLE are lost. As a result, it is necessary to retransmit the packets. The above circumstance represents inefficient resource usage as a whole heterogeneous network.

The present invention is made in view of the above circumstance, and an. Object thereof is to provide, in a heterogeneous communication network constituted of multiple heterogeneous radio communication systems, a communication apparatus and a communication method enabling optimization of frequency resources and time resources, as a whole network.

### Solution to Problem

To address the above-mentioned drawbacks, a control apparatus, a communication system, and a communication method according to the present invention are constituted as follows.

(1) An aspect of the present invention is a control apparatus for communicating with a communication apparatus by using multiple communication methods, the control apparatus including: a transmission and/or reception unit configured to transmit a medium reservation signal indicating that a radiowave is used in a prescribed frequency band by using a first communication method among the multiple communication methods, and, after the medium reservation signal is transmitted, transmit data to the communication apparatus or receive data from the communication apparatus by using at least one communication method among the multiple communication methods; and a radio resource manager configured to manage a radio resource in a frequency and a time in which data is transmitted to the communication apparatus or data is received from the communication apparatus and configure a medium reservation duration indicating a duration in which the radiowave is used, in which the medium reservation signal includes a field for a medium reservation duration indicating a duration in which a radiowave is used, and as the medium reservation duration, a duration longer than a duration in which data is transmitted to or received from the communication apparatus is configured.

(2) Additionally, in an aspect of the present invention, the transmission and/or reception unit uses a different communication method from a first communication method and transmits data to the communication apparatus or receives data from the communication apparatus.

(3) Additionally, in an aspect of the present invention, the transmission and/or reception unit uses at least one communication method among the multiple communication methods to transmit data to multiple communication apparatuses or receive data from multiple communication apparatuses, the radio resource manager allocates a radio resource to each of the multiple communication apparatuses by using time division multiplex, and the medium reservation duration is longer than a duration in which data is transmitted to the communication apparatus or data is received from the communication apparatus by using at least two communication methods.

(4) Additionally, in an aspect of the present invention, the transmission and/or reception unit uses at least two communication methods to transmit data to the communication apparatus or receive data from the, communication apparatus, the radio resource manager allocates a radio resource to the at least two communication methods by time division multiplex, and the medium reservation duration is longer than a duration in which data is transmitted to the communication apparatus or data is received from the communication apparatus by using at least two communication methods.

(5) Additionally, in an aspect of the present invention, the transmission and/or reception unit uses overlapping frequency bands to transmit data to the communication apparatus or receive data from the communication apparatus.

(6) Additionally, in an aspect of the present invention, the transmission and/or reception unit uses overlapping frequency bands in an unlicensed band, to transmit data to the communication apparatus or receive data from the communication apparatus, the multiple communication methods includes a second communication method that transmits or receives data by using an unlicensed band and a licensed band simultaneously, and in a case that data is transmitted to the communication apparatus or data is received from the communication apparatus by using the second communication method, the medium reservation signal is transmitted,

(7) Additionally, in an aspect of the present invention, the transmission and/or reception unit uses multiple communication methods to transmit data to a base station apparatus or receive data from a base station apparatus, and the radio resource manager, in a case of connecting with the communication apparatus, selects an identical communication method to a communication method used for connecting with the base station apparatus.

(8) Additionally, in an aspect of the present invention, the radio resource manager configures a constant medium reservation duration, the radio resource manager configures at least one combination of communication methods that does not exceed the medium reservation duration, and the transmission and/or reception unit uses a selected communication method to transmit data to the communication apparatus or receive data from the communication apparatus.

(9) Additionally, an aspect of the present invention is a communication method of a control apparatus for communicating with a communication apparatus by using multiple communication methods, the communication method including: a transmission and/or reception step of transmitting a medium reservation signal indicating that a radiowave is used in a prescribed frequency band by using a first communication method among the multiple communication methods, and, after the medium reservation signal is transmitted, transmitting data to the communication apparatus or receiving data from the communication apparatus by using at least one communication method among the multiple communication methods; and a radio resource management step of managing a radio resource in a frequency and a time in which data is transmitted to the communication apparatus or data is received from the communication apparatus and configuring a medium reservation duration indicating a duration in which the radiowave is used, in which the medium reservation signal includes a field for a medium reservation duration indicating a duration in which a radiowave is used, and as the medium reservation duration, a duration longer than a duration in which data is transmitted to or received from the communication apparatus is configured.

(10) Additionally, an aspect of the present invention is a communication system including a control apparatus for communicating with a communication apparatus by using multiple communication methods, in which the control apparatus includes: a transmission and/or reception unit configured to transmit a medium reservation signal indicating that a radiowave is used in a prescribed frequency band by using a first communication method among the multiple communication methods, and, after the medium reservation signal is transmitted, transmit data to the communication apparatus or receive data from the communication apparatus by using at least one communication method among the multiple communication methods; and a radio resource manager configured to manage a radio resource in a frequency and a time in which data is transmitted to the communication apparatus or data is received from the communication apparatus and configure a medium reservation duration indicating a duration in which the radiowave is used, the communication apparatus includes a transmission and/or reception unit that, after receiving the medium reservation signal, transmits data to the control apparatus or receives data from the control apparatus, by using at least one communication method among the multiple communication methods, the medium reservation signal includes a field for a medium reservation duration indicating a duration in which a radiowave is used, and as the medium reservation duration, a duration longer than a duration in which data is transmitted to or received from the communication apparatus is configured.

### Advantageous Effects of Invention

According to the present invention, in a heterogeneous communication network constituted of multiple heterogeneous radio communication systems, it is possible to optimize frequency resources and time resources, as a whole network.

### BRIEF DESCRIPTION OF DRAWINGS

FIG. 1 is a diagram illustrating a constitution example of: a radio communication network according to a first embodiment.

FIG. 2 is a diagram illustrating a constitution example of a control apparatus and a communication apparatus according to the first embodiment.

FIG. 3 is an example of radio resource management by the control apparatus according to the first embodiment by using medium reservation.

FIG. 4 is a diagram illustrating a constitution example of a communication network according to a second embodiment.

FIG. 5 is a diagram illustrating a constitution example of a communication apparatus equipped with multiple radio communication system functions according to the second embodiment.

FIG. 6 is an example of radio resource management by a control apparatus according to the second embodiment by using medium reservation.

FIG. 7 is another example of the radio resource management by the control apparatus according to the second embodiment by using the medium reservation.

FIG. 8 is a diagram illustrating a constitution example of a communication network according to a third embodiment,

FIG. 9 is a sequence example in which a control apparatus according to the third embodiment controls frequency resources and time resources of a base station apparatus and a communication apparatus.

FIG. 10 is another sequence example in which the control apparatus according to the third embodiment controls the frequency resources and the time resources of the base station apparatus and the communication apparatus.

### DESCRIPTION OF EMBODIMENTS

### First Embodiment

A communication network according to the present embodiment is built using multiple radio communication systems (communication methods). For example, a Radio Access Network (RAN) such as Long Term Evolution-Advanced (LTE-A), a wireless LAN such as IEEE802.11b, g, or n, Bluetooth (trade name) (hereinafter Bluetooth (trade name) Classic, BLE are included; hereinafter, III), IEEE802.15.4 and the like are combined. Hereinafter, descriptions will be given by taking a communication network built using radio communication systems such as LTE-A, the wireless LAN, and BT as an example. Note that, the radio communication systems according to the present embodiment are distinguished by radio standards, but not limited thereto, Radio communication systems with an identical radio communication standard can be defined as different radio communication systems in a case that the radio communication standard has different releases (e.g., releases of an LTE standard) or versions (e.g., IEEE802.11b, g, n, or Bluetooth (trade name) version 1.0 to 4.0). In a case that different duplex operations (Frequency Division Duplex (FDD), Time Division Duplex (TDD)) are used, the radio communication systems can be defined as different radio communication systems. According to the present embodiment, “X/Y” includes the meaning of “X or Y”. According to the present embodiment, “X/Y” includes the meaning of “X and Y”. According to the present embodiment, “X/Y” includes the meaning of “X and/or Y”. Note that, the present embodiment does not limit the present invention.

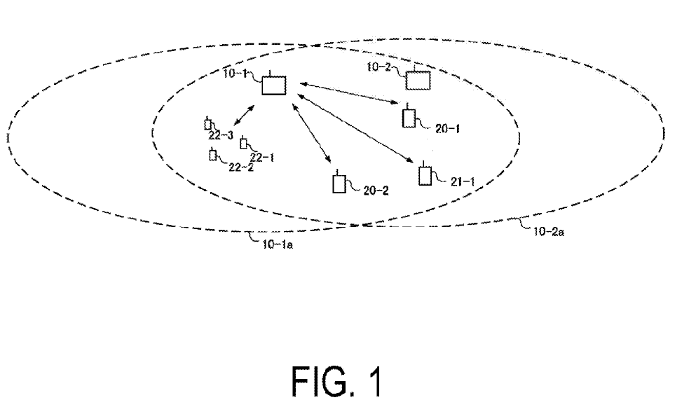

FIG. 1 is a diagram illustrating a constitution example of a communication network according to the present embodiment. The communication network according to the present embodiment includes control apparatuses 10-1, 10-2, communication apparatuses 20-1, 20-2, 21-1, 22-1, 22-2, and 22-3. The number of disposed control apparatuses and communication apparatuses constituting the radio communication network according to the present embodiment is not limited to FIG. 1. The number of disposed apparatuses 10, 20, 21, and 22 is not limited to FIG. 1. The control apparatuses 10-1 to 10-k (k is the number of disposed apparatuses) are also generically referred to as a control apparatus 10. The communication apparatuses 20-1 to 20-l (l is the number or disposed apparatuses) are also generically referred to as a communication apparatus 20. The communication apparatuses 21-1 to 21-m (m is the number of disposed apparatuses) are also generically referred to as a communication apparatus 21. The communication apparatuses 22-1 to 22-n (n is the number of disposed apparatuses) are also generically referred to as a communication apparatus 22.

The control apparatus can connect with the communication apparatus by using multiple radio communication systems (communication methods). The control apparatus 10 is an example of a communication apparatus including communication functions for LTE-A (including LTE), the wireless LAN, and BT. The control apparatus 10 includes functions for a gateway and a router. The control apparatus 10 has a wired or wireless connection with a core communication network such as the Internet (e.g. an IP network, an external network). The control apparatus 10 is connected with a server providing an application or the like used in the communication apparatuses 20 to 22 via the core communication network. Each of the control apparatuses 10-1 and 10-2 builds a subnetwork by using radio communication systems of LTE-A, the wireless LAN, and BT. Coverage 10-1 a is a connectable area (communication area) for the control apparatus 10-1 by using a communication function of the wireless LAN. Coverage 10-2a is a connectable area (communication area) for the control apparatus 10-2 by using a communication Unction of the wireless LAN. The communication apparatus 20 includes a function of the wireless LAN. The communication apparatus 21 includes a function of LTE-A. The communication apparatus 22 includes a function of BT.

In FIG. 1, the control apparatus 10-1 communicates with the communication apparatus 20 by using the function of the wireless LAN. The control apparatus 10-1 communicates with the communication apparatus 21 by using the function of LTE-A. The control apparatus 10-1 communicates with the communication apparatus 22 by using the function of BT. The control apparatus 10 includes a function of an access point in the wireless LAN, a function of a base station apparatus in LTE-A (cNB), and a function of a master node in BT (a central node, central). The communication apparatus 20 includes a function of STA in the wireless LAN. The communication apparatus 21 includes a function of UE LTE-A. The communication apparatus 22 includes a function of a slave node (terminal node, peripheral) in BT. The control apparatus 10-1 communicates with the communication apparatuses 20, 21, and 22 by using an identical frequency band (identical system band). For example, an unlicensed band of a 2.4 GHz band or a 5 GHz band or the like is used. The unlicensed band refers to a frequency band that is not required to have a license from a country or a region. The control apparatus 10-1 can communicate with the communication apparatuses 20, 21, and 22 by using overlapping frequency bands. The control apparatus 10-1 controls frequency resources and time resources of the communication apparatuses 20, 21, and 22. Note that, the control apparatus 10, the communication apparatuses 20, 21, and 22 can have mobility.

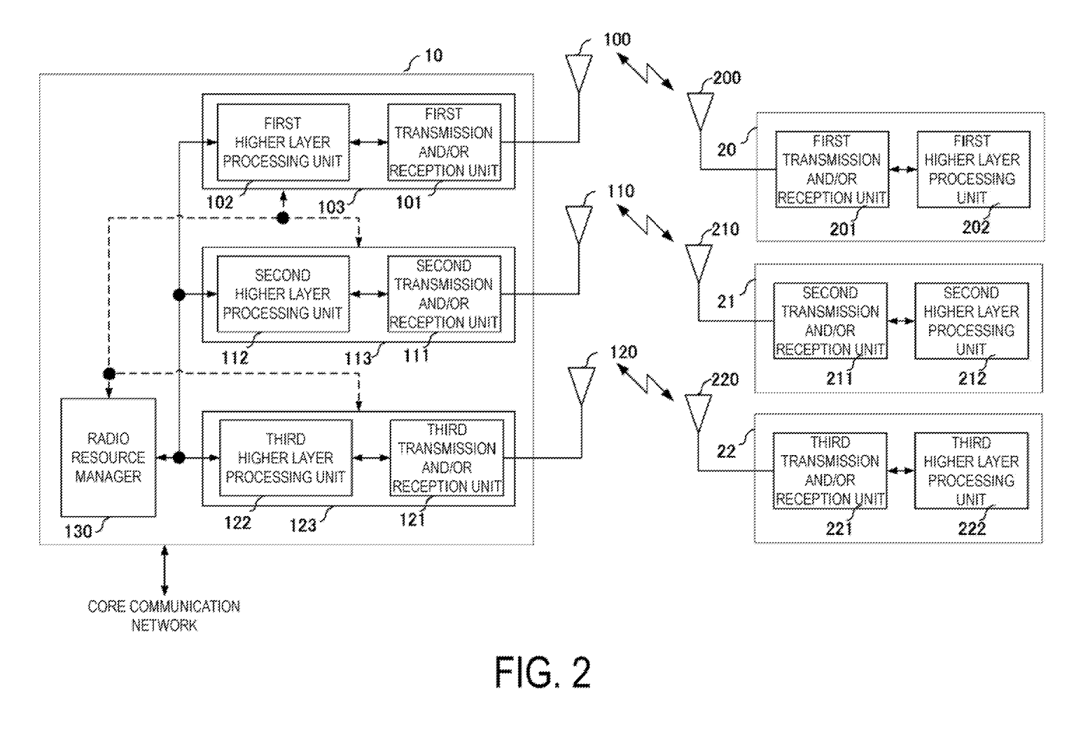

FIG. 2 is a diagram illustrating a constitution example of the control apparatus and the communication apparatus according to the present embodiment. Each of first transmission and/or reception units 101, and 201 processes a Physical Medium Dependent. (PMD) unit in a layer structure of the wireless LAN. Each of first higher layer processing units 102 and 202 processes a higher layer than the physical medium dependent units, for example Physical layer Management Information Base (PHY MIB), a Physical Layer Convergence Protocol (PLCP), and Medium Access Control (MAC) layer, in the layer structure of the wireless LAN.

Each of second transmission and/or reception units 111 and 211 processes a physical layer in a layer structure of LTE-A, Each of second higher layer processing units 112 and 212 processes a higher layer than a physical layer, for example a Medium Access Control (MAC) layer, a Radio Link. Control (RLC) layer, a Packet Data Convergence Protocol (PDCP) layer, and a Radio Resource Control (RRC) layer, in the layer structure of LTE-A.

Each of third transmission and/or reception units 121 and 221 processes a physical layer in a layer structure of BT. Each of third higher layer processing units 122 and 222 processes a higher layer than a physical layer, for example a Link Manager (LM) layer, a Logical Link Control and Adaptive Protocol (L2CAP), an Attribute Protocol (ATT), a Generic Attribute Profile (GATT), and a Generic Access Profile (GAP), in the layer structure of BT.

A first radio communication processing unit 103 performing communication processing of the wireless LAN is constituted of the first transmission and/or reception unit 101 and the first higher layer processing unit 102. A second radio communication processing unit 113 communicating using, LTE-A is constituted of the second transmission and/or reception unit 111 and the second higher layer processing unit 112. A third radio communication processing unit 123 communicating using BT is constituted of the third transmission and/or reception unit 121 and the third higher layer processing unit 122. The first transmission and/or reception unit 101, the second transmission and/or reception unit 111, and the third transmission and/or reception unit 121 are also generically referred to as a transmission and/or reception unit.

Each of the first radio communication processing unit 103, the second radio communication processing unit 113, and the third radio communication processing unit 123 can configure multiple bandwidths to use (frequency channel bandwidths), and multiple data rates. Each of the radio communication processing units can configure a different bandwidth to use, and a different data rate. A radio resource manager 130 can adjust a bandwidth to use, a data rate, or the like, by selecting a radio communication system used to transmit and/or receive data. The radio resource manager 130 configures a medium reservation duration (reservation duration for a frequency/time) according to the radio communication system used to transmit and/or receive data. Processing of each device will be described below.

The control apparatus 10 includes antenna units 100, 110, 120, the first transmission and/or reception unit (first transmission and/or reception step) 101, the first higher layer processing unit (first higher layer processing step) 102, the second transmission and/or reception unit (second transmission and/or reception step) 111, the second higher layer processing unit (second higher layer processing step) 112, the third transmission and/or reception unit (third transmission and/or reception step) 121, the third higher layer processing unit (third higher layer processing step) 122, and the radio resource manager 130.

The first transmission and/or reception unit 101 includes a transmission and/or reception processing function in a physical medium dependent unit of the wireless LAN. The first radio transmission and/or reception unit 101 converts, by down-converting, an Orthogonal Frequency Division Multiplexing (OFDM) signal of the wireless LAN received via the antenna unit 100 into a baseband signal, removes unnecessary frequency components, controls an amplification level to suitably maintain a signal level, and converts an analog signal into a digital signal. The first radio transmission and/or reception unit 101 performs channel estimation, timing detection, or the like by using a preamble signal among the converted digital signals. The preamble signal is a known sequence. Additionally, the first radio transmission and/or reception unit 101 performs Fast Fourier Transform (FFT) on a signal obtained by removing a portion corresponding to a Cyclic Prefix (CP) from the converted digital signal and obtains a signal or each subcarrier. The first radio transmission and/or reception unit 101 demodulates a signal subjected to data modulation such as Binary Phase Shift Keying (BPSK), Quadrature Phase Shift Keying (QPSK), 16 quadrature amplitude modulation (16QAM), 64QAM or the like in each subcarrier. Additionally, the first radio transmission and/or reception unit 101, after the demodulation processing, performs decoding processing for error correction coding, and inputs an information bit constituting an MAC frame to a higher layer processing unit. A unit in which the first radio transmission and/or reception unit 101 transmits and/or receives is referred to as a packet, and corresponds to a block of data constituting the MAC frame.

The first transmission and/or reception unit 101 performs error correction coding process such as convolutional coding on the information bits constituting the MAC frame inputted from the first higher layer processing unit 102, and then performs data modulation process such as the BPSK, the QPSK, or the 16QAM. The first radio transmission and/or reception unit 101 performs Inverse Fast Fourier Transform (Inverse FFT) on the signal subjected to the data modulation process to generate an OFDM symbol, and adds a CP to the OFDM symbol to generate a digital signal of a baseband. Additionally, the first radio transmission and/or reception unit 101 adds a preamble signal that is used for the timing detection, the channel estimation, or the like, and other physical layer header to the digital signal. Further, the digital signal to which the preamble signal or the like is added is converted to an analog signal, up-converted to a carrier frequency, power-amplified, and transmitted via the antenna 101. Note that, a transmission scheme according to the present embodiment is not limited to the OFDM, and a spectrum spread scheme or the like can also be applied.

The first higher layer processing unit 102, based on an MAC frame format of each function of the wireless LAN, reads the information bit inputted from the first radio transmission and/or reception unit 101. The MAC frame format corresponds to a management frame such as a beacon or a probe request, a control frame such as a Request To Send (RTS) frame, or a Clear To Send (CTS) frame, a basic frame including a field containing transmission data, and the like. For example, the first higher layer processing unit 102, based on an MAC frame format of the RTS, reads a Request To Send frame transmitted by the communication apparatus 20. The first higher layer processing unit 102, based on an MAC frame format of CTS, reads a signal indicating Clear To Send transmitted by the communication apparatus 20. The RTS and the CTS are also generically referred to as a medium reservation signal.

Note that, the medium reservation signal can include a basic frame in which a Duration field described later is included in an MAC header, and a basic frame in which a Length field is included in a PHY header. Additionally, the medium reservation signal can include a trigger frame (polling frame) that a prescribed communication apparatus uses to prompt other communication apparatuses to start transmission.

The first higher layer processing unit 102 generates an MAC frame for each function of the Wireless LAN. The MAC frame corresponds to a management frame, a control frame such as an RTS frame or a CTS frame, an ACK frame, a basic frame including a field containing transmission data, and the like The first higher layer processing unit 2012 inputs an information bit written to each of fields constituting the above-described MAC frame to the first radio transmission and/or reception unit 101. For example, based on the MAC frame format of the RTS, an RTS frame (RTS message) is generated. The RTS is a signal indicating that a radiowave of a prescribed frequency band is used (signal indicating transmission prohibition to other communication apparatuses). The RTS can indicate a duration in which a radiowave of a prescribed frequency band is used. The MAC frame of the RTS includes at least information indicating a transmission prohibition (Network Allocation Vector (NAV)) duration. The transmission prohibition duration (NAV duration) is configured in the Duration field (field indicating a duration in which a radiowave of a prescribed frequency band is used, medium reservation duration field) in the MAC frame. The first higher layer processing unit 102, based on the MAC frame format of the CTS, generates a CTS frame (CTS message). The CTS includes a function for indicating reception preparation completion to a communication apparatus transmitting the RTS. Additionally, the CTS includes a function for indicating that a radiowave of a prescribed frequency band is used. The CTS can indicate a duration in which a radiowave of a prescribed frequency band is used. The CTS includes information indicating a transmission prohibition duration.

The CTS includes “CTS to self”. The “CTS to self” includes a function to transmit a CTS frame to oneself and indicate a transmission prohibition duration to neighboring communication apparatuses. The transmission prohibition duration is configured in a Duration field of the CTS frame. The transmission prohibition duration is configured according to radio resource allocation described later, by the radio resource manager 130, to the first radio communication processing unit 103 to the third radio communication processing unit 123.

The first higher layer processing unit 102 can also indicate a transmission prohibition duration by using a basic frame. The transmission prohibition duration is configured by a Duration field of the basic frame. An ACK frame includes a confirmation response (Acknowledgement) function indicating normal reception to a communication apparatus that is a transmission source. The first higher layer processing unit 102 can also configure a transmission prohibition duration by using a Duration field included in an ACK frame. The first higher layer processing unit 102 manages various types of configuration information of the communication apparatus 20 equipped with the wireless LAN.

The second radio communication processing unit 113 can receive and/or transmit a signal of LTE-A, by using a licensed band/unlicensed band. The second radio communication processing unit 113 can generate a cell, by using a licensed band/unlicensed band (also referred to as License Assisted Access (LAA)). The second radio communication processing unit 113 can transmit physical channels simultaneously, by using multiple component carriers constituted of a licensed band and an unlicensed band (also referred to as carrier aggregation).

The second transmission and/or reception unit 111 includes a reception and/or transmission processing function of a physical layer in LTE-A. The second transmission and/or reception unit 111, in a licensed band/unlicensed band, performs down convert processing on a multi-carrier signal (e.g., DFT-spread-OFDM) of LTE-A received via the antenna unit 110. Subsequently, data demodulation processing, decoding processing and the like are performed, and information data (e.g., UpLink-Shared CHannel (UL-SCH) and control data (e.g., Uplink Control Indicator (UCI)) are obtained using a Physical Uplink Shared CHannel (PUSCH), a Physical Uplink Control CHannel (PUCCH), a Physical Random Access CHannel (PRACH), and the like.

The second transmission and/or reception unit 111, by applying an error correction coding process, a data modulation process, or the like, to bits constituting a downlink transport channel inputted from the second higher layer processing unit 112, generates a Physical Broadcast CHannel (PBCH), a Physical Control Format Indicator CHannel (PCFICH), a Physical Hybrid automatic repeat request indicator CHannel (PHICH), a Physical Downlink Shared CHannel (PDSCH), and the like, in LTE-A. The second transmission and/or reception unit 111 generates a Physical Downlink Control CHannel (PDCCH), an Enhanced Physical Downlink Control CHannel (EPDCCH), a synchronization signal, a reference signal that is used for Measurement and channel estimation for demodulation, and the like in LTE-A. The second transmission and/or reception unit 111 allocates the above-described physical channels to resource elements. The resource element is a minimum unit in which a signal constituted of one subcarrier and one OFDM symbol is arranged. The second transmission and/or reception unit 111 performs OFDM modulation on each physical channel allocated to a resource element, up-converts the signal to a carrier frequency of a licensed hand/unlicensed band, power-amplifies the signal, and transmits the signal via the antenna 101.

The second higher layer processing unit 112 obtains information on a terminal apparatus, such as a function of the terminal apparatus (UE capability), included in the information data/control data. The information on the terminal apparatus may be, in addition to a parameter indicating whether the terminal apparatus supports the function, a parameter indicating whether the terminal apparatus has completed implementation and/or testing about the function. The information on the terminal apparatus can include information indicating that the carrier aggregation or the License Assisted Access is supported. The information on the terminal apparatus can include information indicating an operation band/bandwidth of the carrier aggregation supported by the terminal, information indicating an operation band/bandwidth of a licensed band/unlicensed band, and information indicating a subframe capable of being transmitted using, the unlicensed band. The information indicating the operation band/bandwidth may be information indicating a combination of the supported licensed band/unlicensed band.

The second higher layer processing unit 112 generates a signal of a higher layer such as downlink data arranged in a physical downlink shared channel, a radio resource control (RRC) message, or MAC CE, and outputs the signal to the second transmission and/or reception unit 111. The second higher layer processing unit 112 manages various types of configuration information of the communication apparatus 21 equipped with LTE-A. The second higher layer processing unit 112 can signal information indicating that the License Assisted Access is supported, and information indicating the operation band/bandwidth of the carrier aggregation, and the operation band/bandwidth of the licensed hand/unlicensed band, in system information and radio resource control (RRC).

The second radio communication processing unit 113 can constitute a primary cell (Pcell), a secondary cell (Seen), and a secondary primary cell (PScell) in the carrier aggregation. The second radio communication processing unit 113 can configure a licensed band/unlicensed hand for the above cells. The second higher layer processing unit 112 can configure activation/deactivation for an Scell/PScell. The second higher layer processing unit 112 can configure a time at which the Scell/PScell is activated/deactivated.

The second higher layer processing unit 112 can configure information indicating addition/release of a cell that is used for the Scell/PScell. The information indicating the cell that is used for the Scell/PScell includes information of a carrier frequency. The second higher layer processing unit 112 can configure information indicating a subframe using the License Assisted Access in the above cell. The second higher layer processing unit 112 can configure information indicating a start position of a first subframe that is transmitted using the License Assisted Access in the above cell.

The third transmission and/or reception unit 121 includes a transmission and/or reception processing function in a physical layer of BT. The third transmission and/or reception unit 121, performs Gaussian Frequency Shift Keying (GFSK) modulation, and then Frequency Hopping Spread Spectrum (FHSS) processing on an information bit constituting a BT packet inputted from the third higher layer processing unit 122. The second radio transmission and/or reception unit 122, after allocating the signal subjected to the GFSK modulation to a frequency channel of BT by performing the Frequency Hopping spread Spectrum processing, up-converts the signal to a carrier frequency, power-amplifies the signal, and transmits the signal via the antenna 120.

The third transmission and/or reception unit 121 down-converts a signal of BT received via the antenna unit 120 to a baseband signal, and extracts a signal allocated to each frequency channel. The third transmission and/or reception unit 121 performs demodulation process of the GFSK on the signal of each frequency channel. Additionally, the third radio transmission and/or reception unit 121 inputs the information data subjected to the demodulation and constituting a BT packet to the third higher layer processing unit 122.

The third higher layer processing unit 122 generates a communication packet of BT. The communication packet of BT is constituted of an access code, a header, a payload, or the like. The access code is used for synchronization of packets of physical channels, identification, paging, or an inquiry operation. The header includes link control information such as a packet type. Link types of BT include an asynchronous list (Asynchronous Connection-Less (ASL)), a synchronous link (Synchronous Connection-Oriented (SCO)), and the like. The payload includes user information and control information. The communication packet of BT can be constituted of a preamble field for synchronization, an access address field, a Protocol Data Unit (PDU), a CRC check field, and the like.

BT can adopt polling access control. In the polling access control, a master node manages all access rights of slave nodes in a network. The third radio communication processing unit 123 transmits a polling packet at a constant interval. The third higher layer processing unit 122 controls timing at which the polling packet is transmitted (timing at which a slave node accesses).

The third higher layer processing unit 122 can configure a connection interval, slave latency, and an effective connection interval in BT. The connection interval is an interval at which a master communication apparatus gives a connection event to an identical slave communication apparatus. The slave latency is the number of times the slave ignores a polling packet (the maximum number of times of consecutive non-participation in a connection event). The effective connection interval is an interval at which the slave node needs to respond to the polling packet transmitted by the master node. The effective connection interval is calculated as follows: connection interval×(1+slave latency).

The third higher layer processing unit 122 reads, from the third transmission ands/or reception unit 121, response data to the polling packet transmitted to the communication apparatus 22. The third higher layer processing unit 122 reads data in an advertisement packet inputted from the third transmission and/or reception unit 121. The advertisement packet is a packet indicating a BT network participation request transmitted by the communication apparatus 22. The third higher layer processing unit reads, based on a communication packet format of 131, the response data inputted from the third transmission and/or reception unit 121. The third higher layer processing unit can, based on the communication packet format of BT, transmit information data.

The control apparatus 10, via a core communication network, receives information data transmitted by its own apparatus. The control apparatus 10 can receive the above information data in a unit of IP packet. The radio resource manager 130 includes a buffer for storing the above information data. The radio resource manager 130 includes a router function. The radio resource manager 130 distributes the above information data, according to transmission destinations (e.g., IP addresses), to the first radio communication processing unit 103 to the third radio transmission processing unit 123. The radio resource manager 130 inputs a packet having an IP address of the communication apparatus 20 as a destination address to the first radio communication processing unit 103. The radio resource manager 130 inputs a packet having an IP address of the communication apparatus 21 as a destination address to the second radio communication processing unit 113. The radio resource manager 130 inputs a packet having an IP address of the communication apparatus 22 as a destination address to the third radio communication processing unit 123.

The radio resource manager 130 monitors pieces of information data, transmitted by the first radio communication processing unit 103, the second radio communication processing unit 113, and the third transmission processing unit 123. For example, the radio resource manager 130, monitors the number of transmission destinations (the number of communication apparatuses, the number of terminals) of packets transmitted by respective radio communication processing units (packets transmitted using respective radio communication systems) and the number of packets (a data amount). The radio resource manager 130 manages radio parameters of each of the radio communication processing units. The radio resource manager 130 can obtain information indicating radio communication systems installed on the communication apparatuses 20 to 22 and radio parameters thereof, via the first radio communication processing unit to the third radio communication processing unit.

The radio resource manager 130 manages radio resources (frequency resources/time resources) allocated to the first radio resource processing unit 103 to the third radio communication processing unit 123. The radio resource manager 130 configures a timing/frequency channel/Duration field (NAV duration) for transmitting an RTS frame/CTS frame, to reserve a medium (frequency/time reservation) for packet communication of the wireless LAN, LTE-A communication using the LAA, and packet communication of LTE. The radio resource manager 130 notifies the first radio communication processing unit 103 of the timing/frequency channel/Duration field for transmitting the RTS frame/CTS frame configured for the packet communication using the above multiple communication systems. The first radio transmission and/or reception unit 103/first higher layer processing unit 102, based on the above timing/frequency channel/Duration field, processes medium reservation. The radio resource manager 130 can process the medium reservation in a unit of packet/subframe/frame of each communication method.

In FIG. 2, the communication apparatus 20 includes an antenna unit 200, the first transmission and/or reception unit 201 and the first higher layer processing unit 202. Each of the first transmission and/or reception unit 201 and the first higher layer processing unit 202 includes, similar to the first transmission and/or reception unit 101 and the first higher layer processing unit 102, a function for transmission and/or reception of the wireless LAN.

The communication apparatus 21 includes an antenna unit 210, the second transmission and/or reception unit 211, and the second higher layer processing unit 212. Each of the second transmission and/or reception unit 211 and the second higher layer processing unit 212 includes a User Equipment (UE) function of LTE-A. The second transmission and/or reception unit 211 receives downlink information data (PDSCH), downlink control data (PDCCH), and the like, transmitted using a licensed band/unlicensed band. The second transmission and/or reception unit 211 generates uplink information data (PUSCH), uplink control data (PUCCH), and the like. The second transmission and/or reception unit 211 can transmit the above uplink information data and control data by using a licensed band/unlicensed band. The second higher layer processing unit 212 generates information on a terminal apparatus transmitting to the control apparatus 10.

The communication apparatus 22 includes an antenna unit 220, the third transmission and/or reception unit 221, and the third higher layer processing unit 222. Each of the third transmission and/or reception unit 221 and the third higher layer processing unit 222 includes a function of BT. The third transmission and/or reception unit 221 includes a transmission and/or reception processing function similar to the third transmission and/or reception unit 121. The communication apparatus 22 transmits a response packet in response to the polling packet transmitted by the master node, based on the effective connection interval. The third higher layer processing unit 222 reads, from the third transmission and/or reception unit 301, the polling packet transmitted by the control apparatus 10. In a case that the polling packet includes a read request, the third higher layer processing unit 222 inputs the response data to the third transmission and/or reception unit 221.

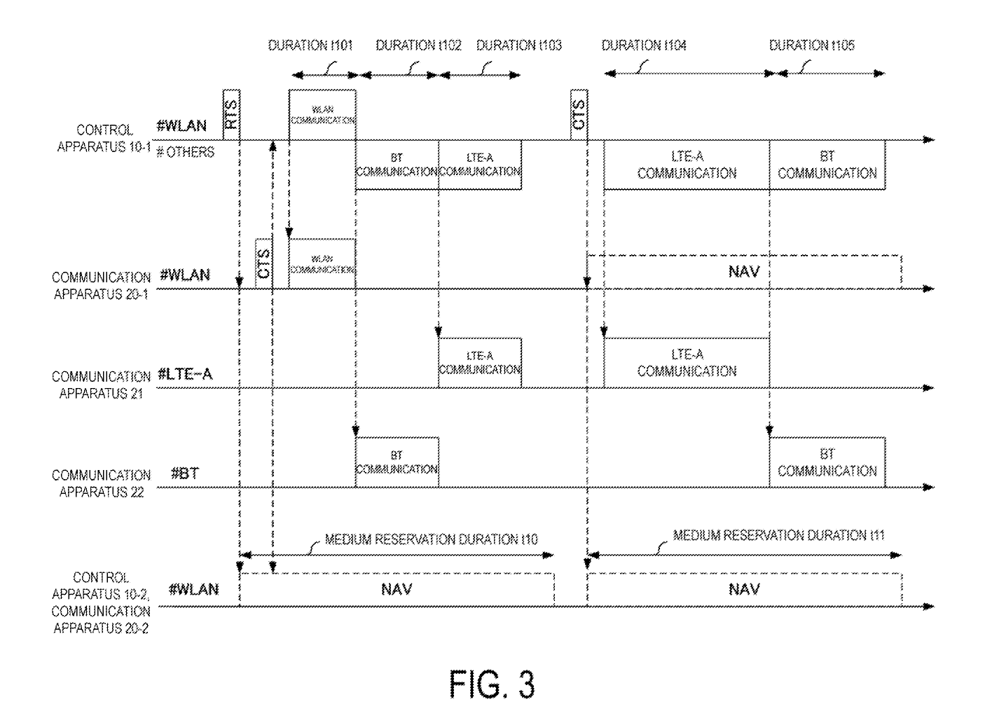

FIG. 3 is an example of radio resource management by the control apparatus according to the present embodiment by using the medium reservation. Assume that, an IP packet addressed to the communication apparatus 20-1, an IP packet addressed to the communication apparatus 21-1, an IP packet addressed to the communication apparatus 22-1 and an IP packet addressed to the communication apparatus 22-2 are stored in a buffer of the radio resource manager 130. The second radio communication processing unit 113 of the control apparatus 10-1, in an Scell, establishes a connection using an unlicensed band. In this case, the radio resource manager 130 of the control apparatus 10-1 configures a medium reservation duration t10 for performing the wireless LAN communication, the LTE-A communication using the LAA, and the BT communication. The radio resource manager 130 performs radio resource management of the wireless LAN communication, the LTE-A communication, and the BI communication by using Time Division Multiplex (TDM). Durations t101, t102, and t103 are durations calculated for the wireless LAN communication, the LTE-A communication using the LAA, and the BT communication, respectively.

For example, the radio resource manager 130 calculates the time resource t101 necessary for the wireless LAN communication, by using the number of IP packets addressed to the communication apparatus 20-1 (a data amount), and radio parameters of the wireless LAN available for addressing to the communication apparatus 20-1 (a frequency bandwidth, MCS, the number of spatial multiplexes, or the like). The radio resource manager 130 calculates time resource t102 necessary for the LTE-A communication (applying the LAA), by using the number of IP packets addressed to the communication apparatus 21-1 (a data amount), and radio parameters of the LTE-A available for addressing to the communication apparatus 21-1 (a frequency bandwidth of an Scell, the number of resource blocks, MCS, the number of spatial multiplexes, a data rate, or the like). The radio resource manager 130 calculates the time resource t103 necessary for the BT communication, by using radio parameters of BT available for addressing to the communication apparatuses 22-1 and 22-2 (a frequency channel, an effective connection interval, and the like), and the number of connected communication apparatuses.

Durations in which the wireless LAN communication, the LTE-A communication using the LAA, and the BT communication are performed (an order of allocating time resources) can be configured using latency tolerated in each IP packet. An example is a case that time resources in the medium reservation duration t10 are allocated according to an ascending order of the latency tolerated in each IP packet, that is, in order of the wireless LAN communication, the BT communication, and the LTE-A communication. This makes it possible to satisfy required conditions for latency of each IP packet, and at the same time efficiently allocate time resources as a whole communication network.

The first radio communication processing unit 103 of the control apparatus 10-1 transmits RTS after a prescribed backoff (e.g., a Short Inter Frame space (SIBS)). The radio communication processing unit 103 stores the medium reservation duration t10 in a Duration field included in the RTS. The radio communication processing unit 103 transmits the RTS in a frequency band in which the wireless LAN communication, the LTE-A communication using the LAA, and the BT communication are performed. The radio communication processing unit 103 transmits RTS having a maximum bandwidth among frequency bandwidths in which the wireless LAN communication, the LTE-A communication using the LAA, and the BT communication are performed. An address of the transmission apparatus 20-1 is stored in the RTS as a transmission address. The control apparatus 10-2 and the communication apparatus 20-2 that receive the RTS, based on a value of the Duration field included in the RTS, suppress transmission of the wireless LAN in an NAV duration (medium reservation duration t10).

The communication apparatus 20-1 that receives the RTS transmits, after a prescribed backoff, CTS to the control apparatus 10-1. The control apparatus 10-1 that receives the CTS transmits a packet to the communication apparatus 20-1 by using the wireless LAN communication (the first radio communication processing unit 103) (the duration t101). The control apparatus 10-1, after the end of the wireless LAN communication, transmits packets to the communication apparatuses 22-1 and 22-2 by using the BT communication (the third radio communication processing unit 123) (the duration t102).

The control apparatus 10-1, after the end of the BT communication, transmits a packet to the communication apparatus 21-1 by using the LTE-A communication (the second radio communication processing unit 113) (the duration t103). The second radio communication processing unit 113 transmits, in the duration t103, a packet to the communication apparatus 21-1, by using carrier aggregation combining a licensed band and an unlicensed band. The second radio communication processing unit 113 can configure activation/deactivation of an Scell/PScell in accordance with the duration t103 (start time and length). The control apparatus 10-1 assists the carrier aggregation combining the licensed band and the unlicensed band, by using a medium reservation function in the wireless LAN communication.

In the medium reservation using the wireless LAN, a duration that can be configured for a Duration field is finite. The control apparatus 10-1 can, in a case that all of IP packets to be transmitted to the communication apparatus 21-1 cannot be transmitted in the medium reservation duration t10, further perform medium reservation. Assume that, following the duration t10, an IP packet addressed to the communication apparatus 21-1 (packet that cannot be transmitted in t10), and IP packets addressed to the communication apparatus 22-1 to the communication apparatus 22-3 are stored in the buffer of the radio resource manager 130. The second radio communication processing unit 113 of the control apparatus 10-1, in an Scell, establishes a connection using an unlicensed band. In this case, the radio resource manager 130 of the control apparatus 10-1 configures a medium reservation duration 111 for performing the LTE-A communication using the LAA, and the BT communication, Durations t104, t105 are durations calculated for the LTE-A communication using the LAA, and the BT communication, respectively.

The radio resource manager 130 calculates the time resource t104 necessary for the LTE-A communication (applying the LAA), by using a size of an IP packet addressed to the communication apparatus 21-1, the number of IP packets, radio parameters of the LTE-A available for addressing to the communication apparatus 21-1 (a frequency bandwidth of an Scell, the number of resource blocks, MCS, the number of spatial multiplexes, or the like). The number of transmitted packets in the duration t104 is larger than that in the duration t103. Accordingly, the duration t104 is configured to be longer than the duration t103 (other radio parameters of LTE-A are similar in the duration t103 and the duration t104).

The radio resource manager 130 calculates the time resource t105 necessary for the BT communication, by using radio parameters of BT available for addressing to the communication apparatuses 22-1 and 22-2 addressed to the communication apparatuses 22-1 to 22-3 (frequency channel, effective connection interval, and the like), and the number of connected communication apparatuses. The number of transmitted communication apparatuses in the duration t105 is larger than that in the duration t102. Accordingly, the duration t105 is configured to be longer than the duration t102 (other radio parameters of BT are similar in the duration t102 and the duration t105).

Durations in which the wireless LAN communication, the LTE-A communication using the LAA, and the BT communication are performed (an order of allocating time resources) can be configured using the respective number or IP packets (data capacity) stored in the buffer. An example is a case that time resources in the medium reservation duration t11 are allocated according to a descending order of the respective number of IP packets stored in the buffer, that is, in order of the LTE-A communication and the BT communication. This makes it possible to prevent saturation of the buffer for each IP packet, and at the same time efficiently allocate time resources as a whole communication network.

The first radio communication processing unit 103 of the control apparatus 10-1 transmits “CTS to self” after a prescribed backoff. The radio communication processing unit 103 stores the medium reservation duration t11 in a Duration field included in the above CTS. The radio communication processing unit 103 transmits the CTS in a frequency band in which the LTE-A communication using the LAA, and the BT communication are performed. The control apparatus 10-2 and the communication apparatuses 20-1 and 20-2 that receive the CTS, based on a value of the Duration field included in the CTS, suppress transmission of the wireless LAN in an NAV duration (medium reservation duration t11).

The control apparatus 10-1, after transmitting the CTS, transmits a packet to communication apparatus 21-1 by using the LTE-A communication (the duration 1104). The control apparatus 10-1, after the end of the LTE-A communication, transmits packets to the communication apparatuses 21-1 to 21-3 by using the BT communication (the third radio communication processing unit 123) (the duration t105). The control apparatus 10-1 may perform carrier sensing before performing each communication in the duration t102, 103, and 105.

As described above, the control apparatus 10-1 configures occupation durations of frequency and time resources, in medium reservation by the wireless LAN, in consideration of durations necessary for communication by other multiple radio communication systems using an identical frequency band. Additionally, the control apparatus 10-1 manages frequency resources and time resources to be allocated to the respective radio communication systems, according to a data amount (the number of packets), required communication quality such as latency, and radio parameters of the respective radio communication systems. Accordingly, in a communication network constituted of multiple radio communication systems using an identical frequency band, it is possible to avoid mutual interference and optimally manage resources in the whole network.

Note that, although in the above, a case in which the control apparatus transmits data to the communication apparatus in a downlink (forward link) is described, a case in which the communication apparatus transmits data to the control apparatus in an uplink (reverse link) can also be applied. For example, the control apparatus 10 can receive, in the LTE-A communication, a Scheduling Request (SR) or the like from the communication apparatus 21, and grasp a data amount of an uplink. The control apparatus 10 can grasp a data amount of an uplink in the BT communication by transmitting a polling packet.

Further, the radio resource manager 130 can perform radio resource management of the wireless LAN communication, the LTE-A communication, and the BT communication by using Frequency Division Multiplex (FDM). In this case, the first radio communication processing unit 103 can transmit a medium reservation signal (e.g., “CTS to self”) to an entire frequency band secured by the control apparatus 10. Subsequently, the radio resource manager 130 can divide the frequency band to which the medium reservation signal is transmitted into at least two frequency bands, and the control apparatus 10 can perform radio communication in each of the frequency hands, based on each of different communication methods. The radio resource manager 130 can further perform the above-described time division multiplex simultaneously.

Additionally, the control apparatus 10-1 and the control apparatus 10-2 can mutually share a radio resource. Each of the control apparatus 10-1 and the control apparatus 10-2 can transmit a medium reservation signal such that mutually transmitted medium reservation signals and radio resources secured by the medium reservation signals do not overlap. For example, the medium reservation signal that each of the control apparatus 10-1 and the control apparatus 10-2 transmits can be subjected to the time division multiplex or the frequency division multiplex.

Further, the control apparatus 10-1 can perform radio communication by using a radio resource secured by the control apparatus 10-2, based on control by the control apparatus 10-2. At this time, the control apparatus 10-2 does not perform radio communication by using a radio resource allocated to radio communication of the control apparatus 10-1. Further, in the case that the control apparatus 10-1 performs the radio communication, by using the radio resource secured by the control apparatus 10-2, based on control by the control apparatus 10-2, the control apparatus 10-1 can also transmit a medium reservation signal again, or perform radio communication without transmitting a medium reservation signal.

Additionally, a medium reservation signal is not limited to being transmitted by the first radio communication processing unit 103. For example, the control apparatus 10 can transmit a medium reservation signal based on the LTE-A communication using the LAA, For example, the control apparatus 10, based on the LTE-A communication using the LAA, can transmit a medium reservation signal, and perform the wireless LAN communication or the BT communication by using a radio resource (for example, a time resource defined in a Maximum Channel Occupancy Time (MCOT)) secured by the above medium reservation signal. The control apparatus 10-1 may perform the carrier sensing before performing each communication by using the above radio resource. It is also possible to configure a duration or the above carrier sensing to be shorter than a carrier sensing duration performed to transmit the medium reservation signal.

### Second Embodiment

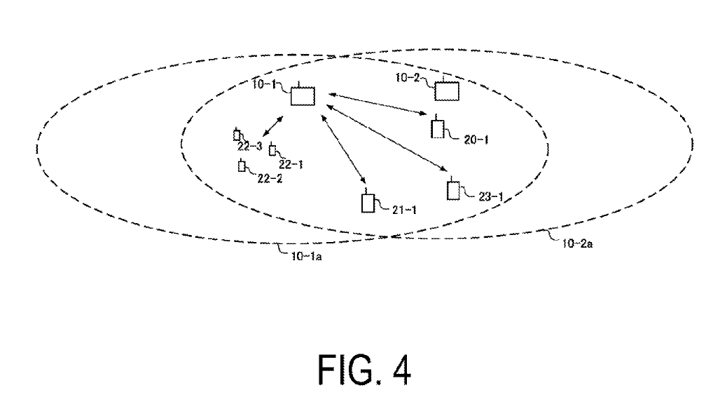

FIG. 4 is a diagram illustrating a constitution example of a communication network according to the present embodiment. The constitution of the communication network in FIG. 4 includes, in addition to the constitution of the communication network in FIG. 1, a communication apparatus 23-1 (collaborative communication apparatus, combo communication apparatus) equipped with multiple radio communication system functions. The number of disposed apparatuses 10, 20, 21, 22 and 23 is not limited to that in FIG. 4. The communication apparatuses 23-1 to 23-p (p is the number of disposed apparatuses) are also generically referred to as a control apparatus 23. The communication apparatuses 10, 20, 21, and 22 have a similar configuration to that in FIG. 2. Note that, the communication apparatus 23 can have mobility.

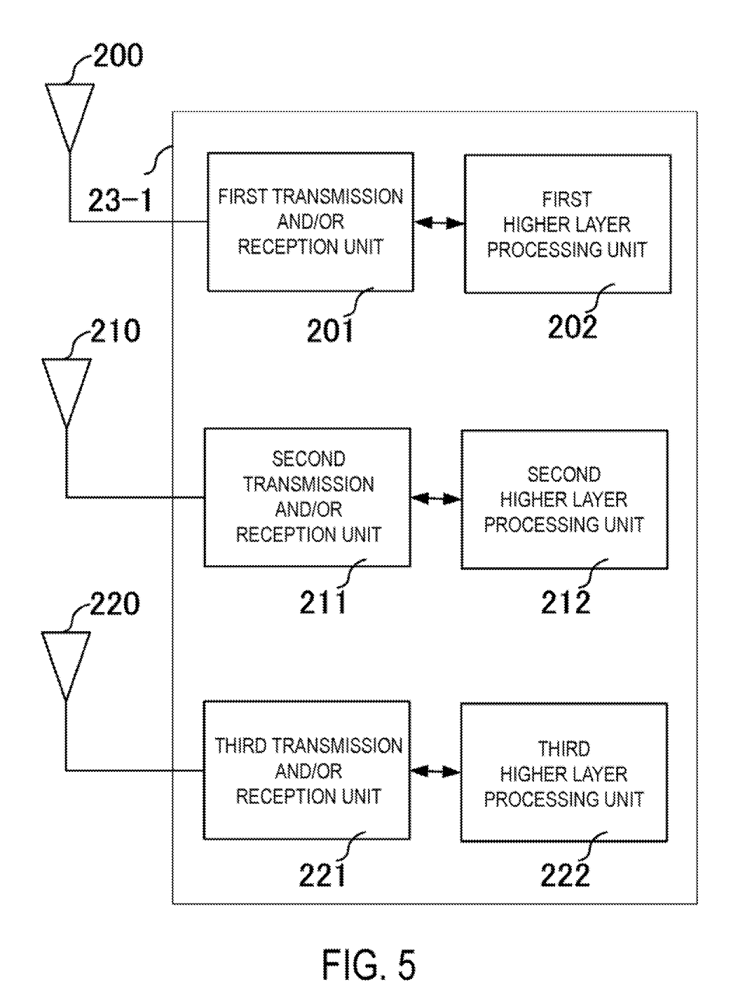

FIG. 5 is a diagram illustrating a constitution example of a communication apparatus equipped with multiple radio communication system functions according to the present embodiment. The communication apparatus 23-1 includes the first transmission and/or reception unit 201 and the first higher layer processing unit 202, and processes radio communication of the wireless LAN. The communication apparatus 23-1 includes the second transmission an for reception unit 211 and the second higher layer processing unit 212, and processes radio communication of LTE-A. The communication apparatus 23-1 includes the third transmission and/or reception unit 221 and the third higher layer processing unit 222, and can process radio communication of BT. The communication apparatus 23-1 can communicate with the control apparatus 10 by using each of the radio communication systems of the wireless LAN, LTE-A, and BT. The radio resource manager 130 can obtain information indicating radio communication systems installed on the communication apparatuses 20 to the communication apparatus 23 and radio parameters thereof, via the first radio communication processing unit to the third radio communication processing unit.

Assume that, a packet addressed to the communication apparatus 23-1 is stored in a buffer of the radio resource manager 130. The radio resource manager 130 determines which of the wireless LAN, LTE-A, and BT is used to transmit the above packet. The radio resource manager 130 can determine a radio communication system to use according to a size of a packet addressed to the communication apparatus 23-1, the number of packets, and radio parameters of a radio communication system available for addressing to the communication apparatus 23-1 (a frequency bandwidth, MCS, the number of spatial multiplexes, or the like). The radio resource manager 130 may determine a radio communication system, according to a type of an application or the like that uses the packet. The radio resource manager 130 may determine a radio communication system, according to communication quality required to the packet. The communication quality includes a data rate, mobility, latency, security, or the like. The radio resource manager 130 may determine a radio communication system, according to a communication distance between the control apparatus 10-1 and the communication apparatus 23-1.

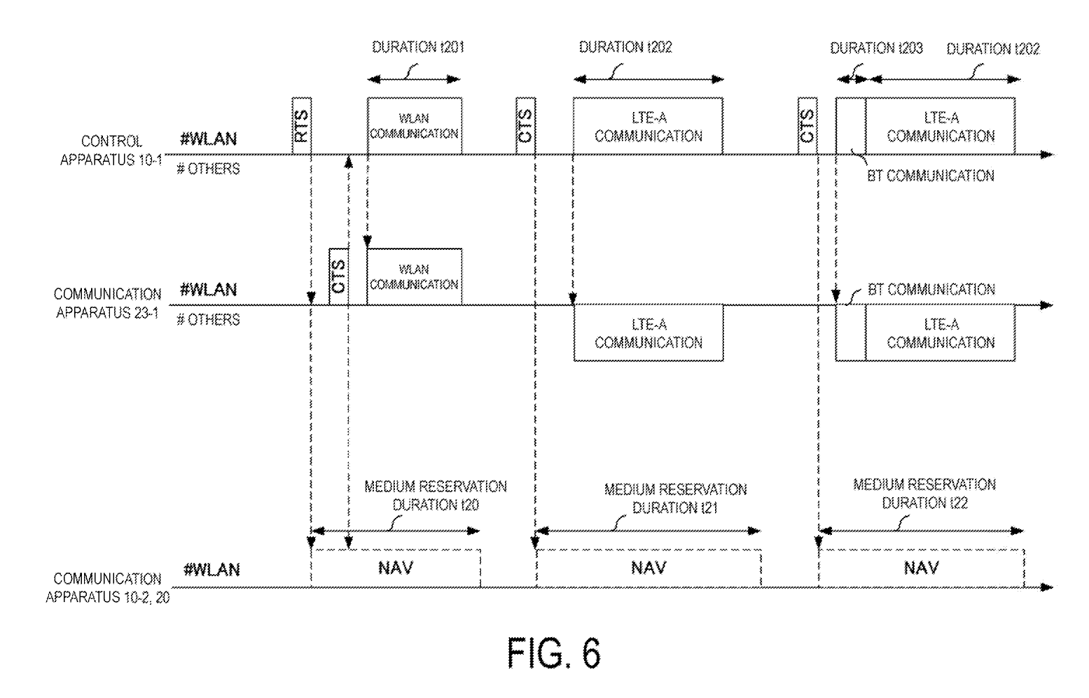

FIG. 6 is an example of the radio resource management by the control apparatus according to the present embodiment by using the medium reservation. The radio resource manager 130 can configure a medium reservation duration according to the radio communication system selected for data transmission to the communication apparatus 23-1. The radio resource manager 130 configures a medium reservation duration t20, by using a Duration field of RTS, for the control apparatus 10-1 to transmit data to the communication apparatus 23-1 by using the wireless LAN communication. The radio resource manager 130 configures a medium reservation duration t21, for the control apparatus 10-1 to transmit data to the communication apparatus 23-1, by using the LTE-A communication (applying the LAA). The radio resource manager 130 configures a medium reservation duration t22, for the control apparatus 10-1 to transmit data to the communication apparatus 23-1, by using the BT communication and the LTE-A communication (applying the LAN). In a case that relationship “a time resource t201 necessary for the wireless LAN communication>a time resource t202 necessary for the LTE-A communication>a time resource t203 necessary for the BT communication” holds, the radio resource manager 130 configures the relationship “the medium reservation duration t20>the medium reservation duration t21>the medium reservation duration t22”.

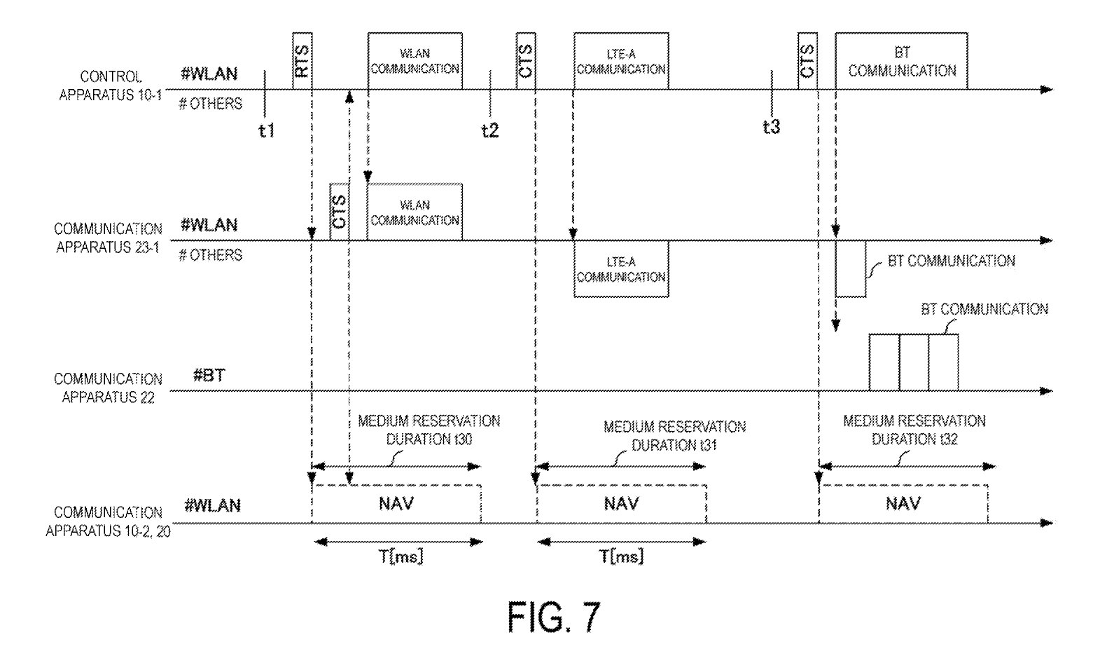

FIG. 7 is another example of the radio resource management by the control apparatus according to the present embodiment by using the medium reservation. The radio resource manager 130 can select a radio communication system satisfying a prescribed medium reservation time. The radio resource manager 130 configures a constant medium reservation duration T. Assume that, a packet addressed to the communication apparatus 23-1 is stored in a buffer of the radio resource manager 130, at each of a time t1 and a time t2. The radio resource manager 130 selects a radio communication system satisfying the medium reservation duration T according to a packet size thereof and the number of packets.

The radio resource manager 130, at the time t1, selects to transmit a packet to the communication apparatus 23-1 by using the wireless LAN communication that completes transmission oft packet within the medium reservation duration T, according to a size of a packet stored in the buffer, or the like. The first radio communication processing unit 103 of the control apparatus 10-1 transmits RTS after a prescribed backoff. The radio communication processing unit 103 sets the medium reservation duration Tin a Duration field included in the RTS. The radio communication processing unit 103 transmits the RIS in a frequency band in which the wireless LAN communication is performed. An address of the transmission apparatus 20-1 is stored in the RTS as a transmission address. The control apparatus 10-2 and the communication apparatus 20 that receive the RTS, based on a value of the Duration field included in the RTS, suppress transmission of the wireless LAN in an NAV duration (medium reservation duration t30). The communication apparatus 20-1 that receives the RTS transmits, after a prescribed backoff, CTS to the control apparatus 10-1. The control apparatus 10-1 that receives the CTS, transmits a packet to the communication apparatus 23-1 by using the wireless LAN communication (the first radio communication processing unit 103).

The radio resource manager 130, at the time t2, selects to transmit a packet to the communication apparatus 23-1 by using the LTE-A communication (applying the LAA) that completes transmission of a packet within the medium reservation duration T, according to a size of a packet stored in the buffer, or the like. The first radio communication processing unit 103 of the control apparatus 10-1 transmits “CTS to self” after a prescribed backoff. The second radio communication processing unit 113 sets the medium reservation duration T in a Duration field included in the above CTS. The second radio communication processing unit 113 transmits the above CTS in a frequency band in which the LTE-A communication using the LAA is performed. The control apparatus 10-2 and the communication apparatus 20 that receive the CTS, based on a value of the Duration field included in the CTS, suppress transmission of the wireless LAN in an NAV duration (medium reservation duration t31). The second radio communication processing unit 113 of the control apparatus 10-1, in an Scell, after establishing a connection using an unlicensed band, transmits a packet to the communication apparatus 23-1 by using the LTE-A communication.

The radio resource manager 130 can also select a radio communication system, comprehensively considering a communication apparatus to connect with the control apparatus 10-1. Assume that, a packet addressed to the communication apparatus 23-1 and packets addressed to the communication apparatus 22-1 to the communication apparatus 22-3 are stored in the buffer of the radio resource manager 130 of the control apparatus 10-1, at a time t3. The radio resource manager 130 selects to transmit a packet to the communication apparatus 23-1 by using a radio communication system (the BT communication) similar to packet transmission addressed to another communication apparatus 22. The first radio communication processing unit 103 of the control apparatus 10-1 transmits “CTS to self” after a prescribed backoff. The third radio communication processing unit 123 sets the medium reservation duration T in a Duration field included in the above CTS. The third radio communication processing unit 123 transmits the above CTS in the frequency band in which the LTE-A communication using the LAA is performed. The control apparatus 10-2 and the communication apparatus 20 that receive the CTS, based on a value of the Duration field included in the CTS, suppress transmission of the wireless LAN in an NAV duration (medium reservation duration t32). The third radio communication processing unit 123 of the control apparatus 10-1, after transmitting the CTS, transmits packets to the communication apparatus 23-1 and the communication apparatus 22 by using the BT communication.

As described above, the control apparatus 10-1 transmits data to a communication apparatus equipped with multiple radio communication systems using an identical frequency band, using a radio communication system selected in consideration of required communication quality, performance of a radio communication system, and a medium reservation duration. Accordingly, in a communication network constituted of multiple radio communication systems using an identical frequency band, it is possible to avoid mutual interference and optimally manage resources in the whole network.

### Third Embodiment

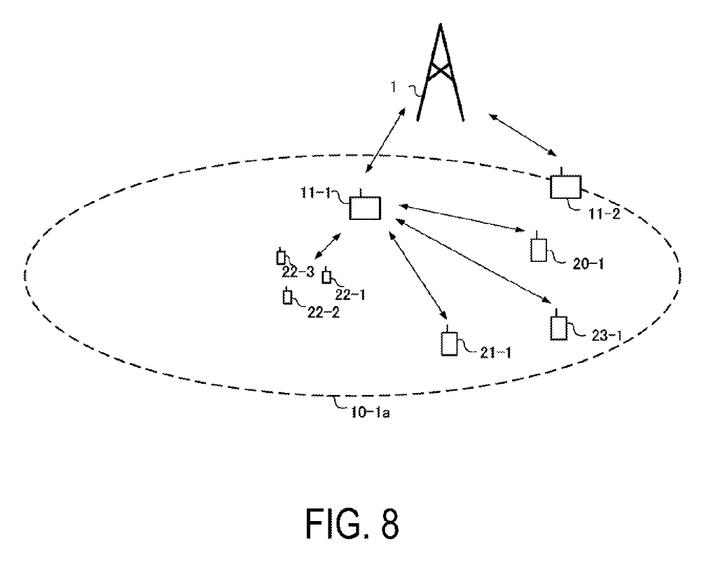

FIG. 8 is a diagram illustrating a constitution example of a communication network according to the present embodiment. The communication network constitution in FIG. 7 includes a base station apparatus 1. (backbone communication apparatus, macro network communication apparatus), control apparatuses 11-1 and 11-2, and the communication apparatuses 20-1, 20-2, 21-1, 22-1, 22-2, and 22-3. The number of disposed apparatuses 11, 20, 21, 22 and 23 is not limited to that in FIG. 7. The communication apparatuses 10, 20, 21, 22 and 23 have a similar configuration to that in FIG. 5. The control apparatuses 11-1 to 11-q (q is the number of disposed apparatuses) are also generically referred to as a control apparatus 11. The control apparatus 11 includes a function for communicating with the base station. apparatus 1, in addition to the control apparatus 10 in FIG. 2. The control apparatus 11 has a similar constitution to the control apparatus 10 in FIG. 2. Hereinafter, differences from the control apparatus 10 will be described, in each unit constituting the control apparatus 11.

The control apparatus according to the present embodiment can connect with the base station apparatus 1 by using multiple communication systems (also referred to as communication methods, regardless of wireless or wired). The first radio communication processing unit 103 of the control apparatus 11 can communicate with the communication apparatus 20, the communication apparatus 23, and the base station apparatus 1, by using a wireless LAN communication system. The second radio communication processing unit 113 of the control apparatus 11 can communicate with the communication apparatus 21, the communication apparatus 23, and the base station apparatus 1, by using an LTE-A communication system. The third radio communication processing unit 123 of the control apparatus 11 can communicate with the communication apparatus 22, the communication apparatus 23, and the base station apparatus 1, by using a BT communication system. The radio resource manager 130 of the control apparatus 11 controls frequency resources and time resources of the communication apparatuses 20 to the communication apparatus 23. Additionally, the radio resource manager 130 of the control apparatus 11 controls frequency resources and time resources between its own apparatus and the base station apparatus 1. Note that, the control apparatus 11 can include multiple first radio communication processing units 103, second radio communication processing units 113, and third radio communication processing units 123, corresponding to each of connections between the base station apparatus and the communication apparatuses.

The control apparatus 11 can select a radio communication system that is used for connecting with the communication apparatus 23, considering a radio communication system used for communication with the base station apparatus 1. In a case of selecting the radio communication system that is used for connecting with the communication apparatus 23, the control apparatus 11 may select an identical radio communication system to the radio communication system used for communication with the base station apparatus 1. The control apparatus 11 can select a radio communication system that is used for connecting with the communication apparatus 23, considering a used bandwidth, a data rate, or the like of a radio communication system used for communication with the base station apparatus. In a case of selecting the radio communication system that is used for connecting with the communication apparatus 23, the control apparatus 11 may select a different radio communication system from the radio communication system used for communication with the base station apparatus 1.

The radio resource manager 130 can select a radio communication system according to the number of IP packets addressed to the communication apparatus 23 (a data amount), and radio parameters of a radio communication system available for addressing to the communication apparatus 23 (a frequency bandwidth, MCS, the number of spatial multiplexes, or the like). The radio resource manager 130 configures a necessary medium reservation duration according to radio communication systems that are used for connecting with the communication apparatus 20 to the communication apparatus 23.

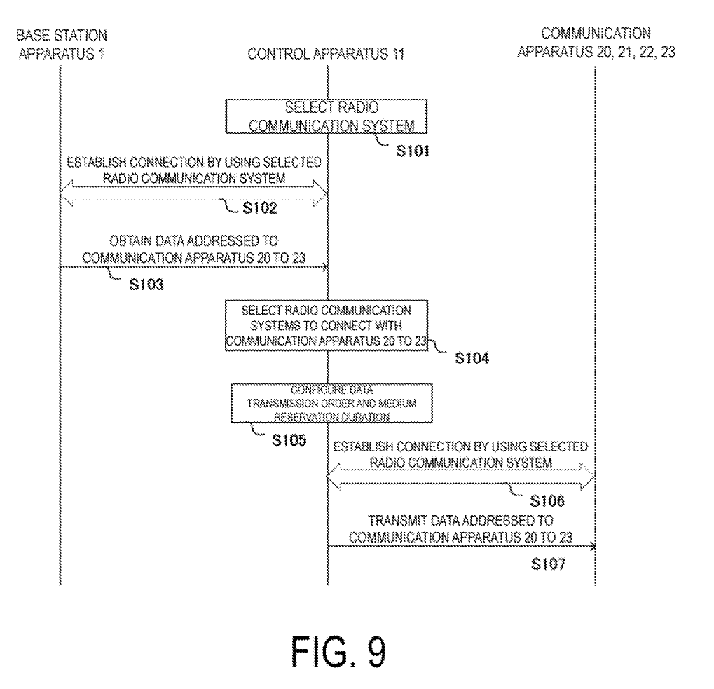

FIG. 9 is a sequence example in which a control apparatus according to the present embodiment controls frequency resources and time resources of a base station apparatus and a communication apparatus. The control apparatus 11 selects a radio communication system to connect with the base station apparatus 1 (S101), and establishes a connection with the base station apparatus 1 by using the radio communication system (S102). The control apparatus 11 may be in a sleep mode together with the base station apparatus 1 before S102, and may transit to a connected mode in S102 (also in the following steps S106, S201 and S204). The control apparatus 11 obtains data addressed to the communication apparatus 20 to the communication apparatus 23 by using the selected radio communication system, from the base station apparatus 1 (S103).

The control apparatus 11 determines a radio communication system to connect with the communication apparatus 20 to the communication apparatus 23, in consideration of communication quality required for the data obtained in S103, communication quality of each radio communication system, or the like (S104). Further, the control apparatus 11 configures an order of transmission of the above data and a medium reservation duration, in consideration of the communication quality required for the data obtained in S103, the communication quality of each radio communication system, or the like (S105). The control apparatus 11 uses the selected radio communication system to establish connections with the communication apparatus 20 to the communication apparatus 23 (S106) and perform data transmission (S107).

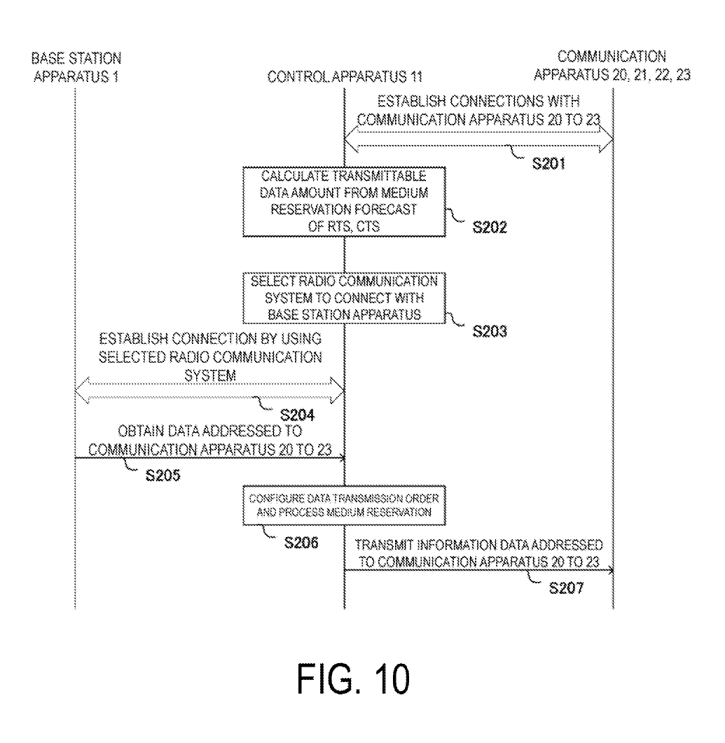

FIG. 10 is another sequence example in which a control apparatus according to the present embodiment controls frequency resources and time resources of a base station apparatus and a communication apparatus. Each of the communication apparatus 20 to the communication apparatus 23 uses a radio communication system installed on its own apparatus to establish a connection for transmitting data to and/or receiving data from the control apparatus 11 (S201). The control apparatus 23 equipped with multiple radio communication systems selects a radio communication system that is used for establishing a connection with the communication apparatus 11, according to communication quality required for data that is transmitted and/or received, an application to which the data belongs, or the like.

The control apparatus 11 calculates a transmittable data amount in the above medium reservation duration, from a medium reservation forecast by RTS/CTS (S202). The control apparatus 11 can forecast medium reservation, according to radio parameters of the radio communication system used for establishing the connections with the communication apparatus 20 to the communication apparatus 23, a transmission frequency band and a transmission frequency bandwidth of RTS/CTS, a configurable medium reservation duration (configuration of a Duration field), or the like. The control apparatus 11 selects a radio communication system that is used for connecting with the base station apparatus 1, according to the calculated transmittable data amount and a transmission timing of RTS/CTS (S203). The control apparatus 11 uses the radio communication system selected in S203 to establish a connection for transmitting data to and/or receiving data from the base station apparatus 1 (S204).

The control apparatus 11 receives data to be transmitted to the communication apparatus 20 to the communication apparatus 23, by using the radio communication system for which the connection is established in S204, from the base station apparatus 11 (S205). In S205, the control apparatus 11 can process medium reservation by using the selected radio communication system. The control apparatus 11 configures an order of data transmission in the medium reservation duration and processes medium reservation (RTS/CTS transmission) by using data capacity addressed to the communication apparatus 20 to the communication apparatus 23 obtained in S105, required communication quality, or the like (S206). The control apparatus 11, after medium reservation completion, transmits data to the communication apparatus 20 to the communication apparatus 23 (S207). In FIG. 9, the medium reservation processing illustrated in FIG. 3, FIG. 6, and FIG. 7 can be applied to the control apparatuses and the communication apparatuses according to the present embodiment.

As described above, the control apparatus 10-I manages, in consideration of a medium reservation duration by the wireless LAN, frequency resources/radio resources that are used for connecting with the base station apparatus and frequency resources/radio resources that are used for connecting with the communication apparatus 20 to the communication apparatus 23. Accordingly, in a communication network constituted of multiple radio communication systems using an identical frequency band, it is possible to avoid mutual interference and optimally manage resources in the whole network.

Note that, a program running, on the communication apparatus according to the present invention is a program that controls CPU and the like (a program for causing a computer to operate) in such a manner as to enable the functions according to the above-described embodiment of the present invention. The information handled by these apparatuses is temporarily held in a RAM at the time of processing, and is then stored in various types of ROMs, HDDs, and the like, and read out by the CPU as necessary to be edited and written. Here, a semiconductor medium fa ROM, a non-volatile memory card, or the like, for example), an optical recording medium (DVD, MO, MD, CD, BD, or the like, for example), a magnetic recording, medium (a magnetic tape, a flexible disk, or the like, for example), and the like can be given as examples of recording media for storing the programs. In addition to enabling the functions of the above-described embodiments. by performing loaded programs, the functions of the present invention are enabled by the programs running cooperatively with an operating system, other application programs, or the like in accordance with instructions included in those programs.

In a case of delivering these programs to market, the programs can be stored in a portable recording medium, or transferred to a server computer connected via a network such as the Internet. In this case, the storage device serving as the server computer is also included in the present invention. Furthermore, some or all the communication apparatuses in the above-described embodiments may be enabled as LSI, which is typically an integrated circuit. Each of the functional blocks of the communication apparatus may be individually enabled as chips, or may be partially or completely integrated into a chip. In a case that the functional blocks are integrated into a chip, an integrated circuit controller for controlling them is added.

Furthermore, a circuit integration technique is not limited to the LSI, and may be achieved with a dedicated circuit or a general-purpose processor. Furthermore, in a case where with advances in semiconductor technology, a circuit integration technology with which an LSI is replaced appears, it is also possible to use an integrated circuit based on the technology.

Note that the invention of the present patent application is not limited to the above-described embodiments. The communication apparatus according to the invention of the present patent application is not limited to the application in the mobile terminal, and, needless to say, can be applied to a fixed-type electronic apparatus installed indoors or outdoors, or a stationary-type electronic apparatus, for example, an AV apparatus, a kitchen apparatus, a cleaning or washing machine, an air-conditioning apparatus, office equipment, a vending machine, and other household apparatuses.

The embodiments of the invention have been described in detail thus far with reference to the drawings, but the specific configuration is not limited to the embodiments. Other designs and the like that do not depart from the essential spirit of the invention also fall within the scope of the patent claims.

### INDUSTRIAL APPLICABILITY

The present invention can be preferably used in a communication apparatus an(a communication method.

The present international application claims priority based on JP 2016-052037 filed on Mar. 16, 2016, and all the contents of JP 2016-052037 are incorporated in the present international application by reference.

### REFERENCE SIGNS LIST

1 Base station apparatus
10-1, 10-2, 11-1, 11-2 Control apparatus
20-1 Communication apparatus equipped with wireless LAN
21-1 Communication apparatus equipped with LTE-A
22-1, 22-2, 22-3 Communication apparatus equipped with BT
23-1 Communication apparatus equipped with functions of multiple radio communication systems
10-1a, 10-2a Communication area of wireless LAN
100, 110, 120, 200, 210, 220 Antenna unit
101, 201 First transmission and/or reception unit
102, 202 First higher layer processing unit
103 First radio communication processing unit
111, 211 Second transmission and/or reception unit
112, 212 Second higher layer processing unit
113 Second radio communication processing unit
121, 221 Third transmission and/or reception unit
122, 222 Third higher layer processing unit
123 Third radio communication processing unit
130 Radio resource manager

1. A control apparatus for communicating with a communication apparatus by using multiple communication methods, the control apparatus comprising:
a transmission and/or reception unit configured to transmit a medium reservation signal indicating that a radiowave is used in a prescribed frequency band by using a first communication method among the multiple communication methods, and, after the medium reservation signal is transmitted, transmit data to the communication apparatus or receive data from the communication apparatus by using at least one communication method among the multiple communication methods; and
a radio resource manager configured to manage a radio resource in a frequency and a time in which data is transmitted to the communication apparatus or data is received from the communication apparatus and configure a medium reservation duration indicating a duration in which the radiowave is used,
wherein the medium reservation signal includes a field for a medium reservation duration indicating a duration in which a radiowave is used, and
as the medium reservation duration, a duration longer than a duration in which data is transmitted to or received from the communication apparatus is configured.

2. (canceled)

3. (canceled)

4. The control apparatus according to claim 1,
wherein the transmission and/or reception unit is configured to use at least two communication methods to transmit data to the communication apparatus or receive data from the communication apparatus,
the radio resource manager is configured to allocate a radio resource to the at least two communication methods by time division multiplex, and
the medium reservation duration is longer than a duration in which data is transmitted to the communication apparatus or data is received from the communication apparatus by using at least two communication methods.

5. The control apparatus according to claim one of claims 1 to
wherein the transmission and/or reception unit is configured to use overlapping frequency bands to transmit data to the communication apparatus or receive data from the communication apparatus.

6. The control apparatus according to claim 4,
wherein the transmission and/or reception is configured to unit use overlapping frequency bands in an unlicensed band, to transmit data to the communication apparatus or receive data from the communication apparatus,
the multiple communication methods include a second communication method of transmitting or receiving data by using an unlicensed band and a licensed band simultaneously, and
in a case that data is transmitted to the communication apparatus or data is received from the communication apparatus by using the second communication method, the medium reservation signal is transmitted.

7. The control apparatus according to claim 4,
wherein the transmission and/or reception unit is configured to use multiple communication methods to transmit data to a base station apparatus or receive data from a base station apparatus, and
the radio resource manager, in a case of connecting with the communication apparatus, is configured to select an identical communication method to a communication method used for connecting with the base station apparatus.

8. The control apparatus according to claim 4,
wherein the radio resource manager is configured to configure a constant medium reservation duration,
the radio resource manager is configured to configure at least one combination of communication methods that does not exceed the medium reservation duration, and
the transmission and/or reception unit is configured to use a selected communication method to transmit data to the communication apparatus or receive data from the communication apparatus.

9. A communication method of a control apparatus for communicating with a communication apparatus by using multiple communication methods, the method comprising the steps of:
transmitting a medium reservation signal indicating that a radiowave is used in a prescribed frequency band by using a first communication method among the multiple communication methods, and, after the medium reservation signal is transmitted,
transmitting data to the communication apparatus or receiving data from the communication apparatus by using at least one communication method among the multiple communication methods; and
managing a radio resource a frequency and a time in which data is transmitted to the communication apparatus or data is received from the communication apparatus and configuring a medium reservation duration indicating a duration in which the radiowave is used,
wherein the medium reservation signal includes a field for a medium reservation duration indicating a duration in which a radiowave is used, and
as the medium reservation duration, a duration longer than a duration in which data is transmitted to or received from the communication apparatus is configured.

10. A communication system including a control apparatus for communicating with a communication apparatus by using multiple communication methods,
wherein the control apparatus includes:
a transmission and/or reception unit configured to transmit a medium reservation signal indicating that a radiowave is used in a prescribed frequency band by using a first communication method among the multiple communication methods, and, after the medium. reservation signal is transmitted, transmit data to the communication apparatus or receive data from the communication apparatus by using at least one communication method among the multiple communication methods; and
a radio resource manager configured to manage a radio resource in a frequency and a time in which data is transmitted to the communication apparatus or data is received from the communication apparatus and configure a medium reservation duration indicating a duration in which the radiowave is used,
the communication apparatus includes a transmission and/or reception unit that, after receiving the medium reservation signal, is configured to transmit data to the control apparatus or receives data from the control apparatus, by using at least one communication method among the multiple communication methods,
the medium reservation signal includes a field for a medium reservation duration indicating a duration in which a radiowave is used, and
as the medium reservation duration, a duration longer than a duration in which data is transmitted to or received from the communication apparatus is configured.

11. The control apparatus according to claim 4,
wherein the transmission and/or reception unit is configured to use a different communication method from a first communication method and transmits data to the communication apparatus or receives data from the communication apparatus.

12. The control apparatus according to claim 4,
wherein the transmission and/or reception unit is configured to use at least one communication method among the multiple communication methods to transmit data to multiple communication apparatuses or receive data from multiple communication apparatuses,
the radio resource manager is configured to allocate a radio resource to each of the multiple communication apparatuses by using time division multiplex, and
the medium reservation duration is longer than a duration in which data is transmitted to the communication apparatus or data is received from the communication apparatus by using at least two communication methods.
